(19) United States
(12) Patent Application Publication
(10) Pub. No.: US 2002/0119876 A1
(43) Pub. Date: Aug. 29, 2002

(54) Cushioning conversion machine with stock roll transfer assembly

(76) Inventors: Harry H. Lu, Mentor, OH (US); Thomas E. Manley, Mentor, OH (US); Joseph J. Harding, Mentor, OH (US)

Correspondence Address: Paul R. Steffes, Renner, Otto, Boisselle & Sklar, LLP, Nineteenth Floor, 1621 Euclid Avenue, Cleveland, OH, 44115-2191, US

(21) Appl. No.: 10/037,780

(22) Filed: Oct. 19, 2001

Related U.S. Application Data
(60) Provisional application No. 60/241,677, filed on Oct. 19, 2000.
(60) Provisional application No. 60/315,674, filed on Aug. 28, 2001.

(51) Int. Cl. B31F 5/02

(52) U.S. Cl. 493/350

(57) ABSTRACT

A system that converts the stock material into a cushioning product has associated therewith a conversion assembly which converts the stock material into the cushioning product and a stock roll loading assembly. The stock roll loading assembly includes a frame, a stock roll transfer member, and a ramp. The stock roll transfer member is mounted to the frame for movement between a load position whereat a stock roll may be loaded thereon and a release position whereat the stock roll is released from the transfer member. The ramp receives the stock roll from the transfer member and conveys the stock roll to a position remote from the release position. In an embodiment, the stock roll transfer member is loaded from an end thereof. In another embodiment, the stock roll transfer member is loaded from the side thereof. A stock roll storage assembly stores one or more stock rolls and enables the stock rolls to be sequentially released from the ramp.

### RELATED APPLICATION DATA

This application claims priority benefit under 35 U.S.C. 119(e) of U.S. Provisional Application No. 60/241,677, entitled “CUSHIONING CONVERSION MACHINE WITH STOCK ROLL TRANSFER ASSEMBLY,” filed Oct. 19, 2000; and U.S. Provisional Application No. 60/314,674, entitled “CUSHIONING CONVERSION MACHINE WITH STOCK ROLL TRANSFER ASSEMBLY,” filed Aug. 28, 2001.

### FIELD OF THE INVENTION

The present invention relates to a cushioning conversion system for producing a cushioning dunnage product from sheet stock material supplied in roll form and, more particularly, to an improved stock roll transfer assembly for loading and storing one or more stock rolls and releasing a stock roll for supply of the stock material to a cushioning conversion machine employed in the system.

### BACKGROUND

Cushioning conversion machines, also referred to as dunnage converters, heretofore have been employed to convert sheet stock material of one or more plies into a dunnage product useful in the packing of items in containers such as boxes for shipment. The sheet stock material is usually supplied in a roll from which the sheet stock material is payed off as it is being converted by the converter.

The stock roll typically is supported at the upstream end of the converter by means of a spindle in the form of an axle rod. The axle rod passes through the core of the stock roll with its ends projecting therebeyond for cradled receipt in respective laterally spaced apart spindle supports of a stock roll holder. The spindle supports may be provided, for example, directly on the frame of the converter or on a mobile cart of the type shown in U.S. Pat. No. 5,123,889.

The stock roll typically is loaded on the machine or cart by positioning the stock roll on the floor or on a stand near the converter. The axle rod would then be inserted into the center hole in a plug at one end of the roll, through the core tube and then through the center hole in a plug at the opposite end of the roll. The stock roll could then be raised to the level of the stock roll supports on the machine or cart by grasping and lifting the ends of the axle rod that project from opposite ends of the stock roll. The loading operation is completed by lowering the projecting ends of the axle rod onto the laterally spaced apart spindle supports that have recesses for cradled receipt and retention of the axle rod.

In some situations, such as where a machine operator is unable to lift the stock rolls, an attendant may be designated to lift and load a stock roll on the machine. In these situations, the operator may have to call or search for the attendant, and delay may arise when the attendant is not available to load a stock roll on the machine. Consequently, the operator of the machine is prevented from performing packing operations until the attendant returns to the machine and loads a new stock roll. The delay may be of considerable length in those situations where the attendant is charged with other tasks or otherwise not available.

### SUMMARY

The present invention provides a cushioning conversion system and method which make it easier for an operator to position a stock roll in an operating position from which the stock material is fed into a conversion machine and/or provide for storage of one or more stock rolls that can be easily moved into the operating position when needed. More particularly, one or more stock rolls are stored in a queue from which a stock roll can be released to the operating position for supply of stock material to the conversion machine. In a preferred embodiment, a plurality of stock rolls can be stored on a storage ramp and the machine operator may replace a spent stock roll simply by operating a roll release lever to release a new stock roll from the storage ramp to the operating position without having to lift the stock roll. Thus, the machine operator, or an attendant, may load multiple stock rolls onto the ramp prior to, for example, the machine operator's shift. In this way, multiple stock rolls are available for easy and quick replacement of a spent roll.

According to one aspect of the invention, a system for producing a dunnage product from a roll of sheet stock material comprises a converter which converts the stock material into the dunnage product and a stock roll storage assembly. The stock roll storage assembly includes a storage ramp for supporting one or more stock rolls in a queue and a roll release dog at the lower end of the ramp which is selectively operable to release a stock roll from the queue for passage to an operating position.

The roll release dog may be movable between a roll holding position precluding movement of a stock roll thereby and a roll release position allowing the stock roll to move away from the storage ramp and along an inclined guide to and against a stop at the end of the inclined guide. The roll release dog preferably is operated by a manually operated lever readily accessible to the operator. The lever may be U-shaped and connected by a linkage assembly to the roll release dog. The U-shaped lever has the base thereof conveniently located forwardly of the operating position of the stock roll with the legs thereof extending rearwardly and straddling the stock roll.

Still further, the roll release dog may be spring biased to the roll holding position so that when the roll release dog is moved to the roll released position, to release a stock roll from the storage area, the roll release dog automatically returns to the roll holding position to block a succeeding stock roll from moving from the storage area. The roll release dog may include a roll pusher projection operative to nudge one of the one or more stock rolls from the storage area to the operating position. Still further, the roll storage assembly may include a latch mechanism for selectively locking the roll release lever in the first position.

Also, a power actuator may be included for powering the roll release dog between the roll holding position and the roll release position.

The stock roll storage assembly may also include a roll holding dog upstream of the roll release dog. The roll holding dog coacts with the movement of the roll release dog to temporarily block a succeeding roll in the storage area when the roll release dog releases a stock roll and acts to release the succeeding stock roll to the roll release dog when the roll release dog is returned to its roll holding position.

According to another aspect of the invention, the stock roll storage assembly includes a cradle assembly pivotably mounted to a frame for movement between an inclined position relative to the horizontal whereat stock rolls are urged by gravity to a storage area, and a reverse inclined position relative to the horizontal whereat the at least one of said stock rolls in the storage area is urged by gravity to an operating position. The cradle assembly is pivotably biased toward the inclined position.

The cradle assembly may include a height adjuster arm having first and second apertures, and the stock roll storage assembly further includes a latch pin insertable into the first aperture to maintain the cradle assembly in the inclined position and insertable into the second aperture to maintain the cradle assembly in the reverse inclined position.

According to a further aspect of the invention, a system for producing a dunnage product from a roll of sheet stock material comprises a conversion assembly which converts the stock material into the cushioning product, and a stock roll loading assembly. The stock roll loading assembly includes a frame and a stock roll transfer member mounted to the frame for movement between a load position whereat a stock roll may be loaded thereon and a release position whereat the stock roll is released from the transfer member. A ramp is provided for receiving the stock roll from the transfer member and conveying the stock roll to a position remote from the release position.

In a preferred embodiment, the ramp includes a pair of elevated laterally spaced apart storage rails mounted to the frame for storing one or more stock rolls thereon, and the stock roll transfer member includes a pair of laterally spaced apart roll lifter arms mounted to the frame for movement between the load position and the release position. A lever may be connected to the lifter arms by a linkage assembly for raising and lowering the lifter arms, and the roll lifter arms may include respective catches which are configured to engage the projecting ends of a spindle supporting a stock roll when the lifter arms are raised to lift a stock roll to the release position for transfer onto the ramp. The stock roll transfer member may include a V-shaped cradle assembly pivotally mounted to the frame about a transverse axis between the loading position and the release position, the V-shaped cradle assembly including first and second angularly spaced apart walls adapted for laterally receiving a stock roll therebetween when the cradle assembly is in the loading position. The V-shaped cradle assembly may be biased towards the release position such that when a stock roll is installed on the angularly spaced apart walls the V-shaped cradle assembly pivots about the transverse axis to the release position, whereat the stock roll is deposited onto the ramp.

The foregoing and other features of the invention are hereinafter fully described and particularly pointed out in the claims, the following description and the annexed drawings setting forth in detail plural illustrative embodiments of the invention, such being indicative, however, of but a few of the various ways in which the principles of the invention may be employed.

### BRIEF DESCRIPTION OF THE DRAWINGS

FIG. 1 is a side elevational view of a cushioning conversion system including a stock roll transfer assembly in accordance with the present invention.

FIG. 2 is a side view of an exemplary conversion machine useful in the cushioning conversion system, the side panel of the machine nearest the viewer being removed to illustrate internal components of the machine.

FIG. 3 is a side elevational view of the stock roll transfer assembly of FIG. 1, showing roll lifter arms of such assembly in a ready to lift position and a stock roll in a storage position, and showing in phantom different size stock rolls at a loading position and different size stock rolls at an operating position of the stock roll transfer assembly.

FIG. 4 is a top plan view of the stock roll transfer assembly as seen from the plane 4-4 in FIG. 3, showing a stock roll in the operating position of the stock roll transfer assembly.

FIG. 5 is an end elevational view of the stock roll transfer assembly as seen from the plane 5-5 in FIG. 3, showing a stock roll in the storage position of the stock roll transfer assembly.

FIG. 5a is a broken view of an alternative storage rail and spindle arrangement in accordance with the present invention.

FIG. 5b is a

FIGS. 6 through 8 are side elevational views of a stock roll loading assembly of the stock roll transfer assembly, sequentially illustrating the manner in which a stock roll is loaded into the cushioning conversion system in accordance with the method of the present invention.

FIG. 9 is a side elevational view of another embodiment of a stock roll transfer assembly in accordance the invention, showing cradle arms of such assembly in a ready to release position and a stock roll in a storage position, and showing in phantom different size stock rolls at a loading position, a stock roll in a falling zone intermediate that of the loading position and storage position, and different size stock rolls at an operating position of the stock roll transfer assembly.

FIG. 10 is a top plan view of the FIG. 9 stock roll transfer assembly as seen from the plane 10-10 in FIG. 9, showing a stock roll in the operating position of the stock roll transfer assembly.

FIG. 11 is a broken view of the FIG. 3 stock roll transfer assembly, showing in greater detail a stock roll storage assembly thereof.

FIGS. 12 through 14 are side elevational views of a stock roll storage assembly of the stock roll transfer assembly, showing plural rolls in the storage position and sequentially illustrating the manner in which a stock roll is released from a ready to release position to the operating position of the stock roll transfer assembly.

FIG. 15 is a side elevational view of still another embodiment of a stock roll transfer assembly in accordance with the invention, showing a cradle assembly thereof in an inclined position and showing in phantom stock rolls at the storage end of the stock roll transfer assembly.

FIG. 16 is a top plan view of the FIG. 15 stock roll transfer assembly as seen from the plane 16-16 in FIG. 15.

FIG. 17 is an end elevational view of the FIG. 15 stock roll transfer assembly as seen from the plane 17-17 in FIG. 15, showing in phantom a stock roll on the cradle assembly.

FIG. 18 is a side elevational view of the FIG. 15 stock roll transfer assembly, showing the cradle assembly thereof in a reverse inclined position and showing in phantom stock rolls at the storage end and a stock roll at a loading/operating end of the stock roll transfer assembly.

FIG. 19 is a side elevational view of the FIG. 15 stock roll transfer assembly, showing the cradle assembly thereof in a reverse inclined position and showing in phantom a stock roll being released from a storage area of the stock roll transfer assembly.

FIG. 20 is an enlarged end view of a roll release dog and surrounding components of the stock roll transfer assembly of FIG. 15.

FIG. 21 is an enlarged side view of the roll release dog and surrounding components of the stock roll transfer assembly of FIG. 15.

FIG. 22 is a broken view of the FIG. 15 stock roll transfer assembly with a spring biased roll stop.

FIG. 23 is a broken view of the FIG. 15 stock roll transfer assembly with storage rails thereof having recessed portions.

### DETAILED DESCRIPTION

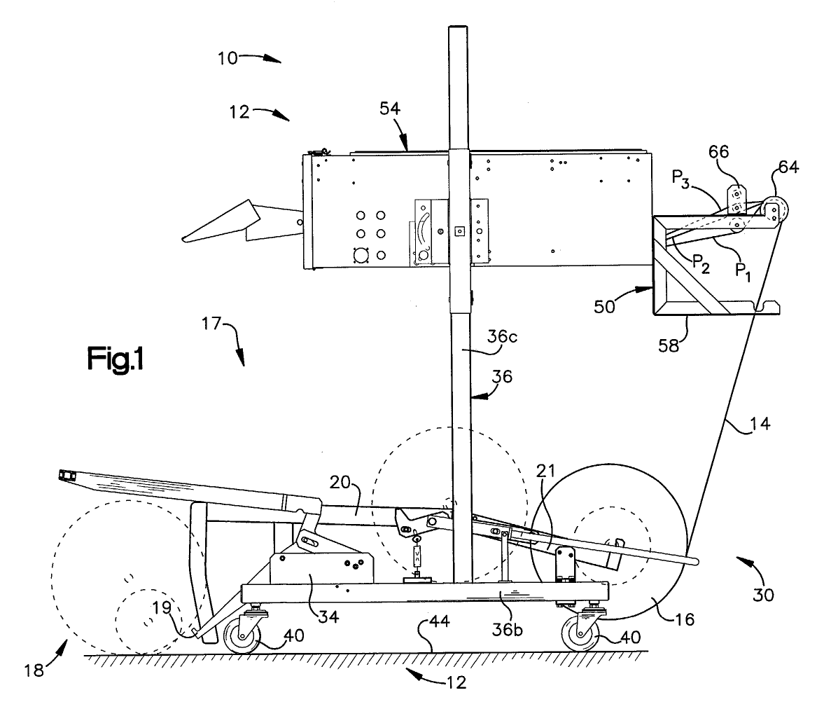

Referring now in detail to the drawings and initially to FIG. 1, there is illustrated a cushioning conversion system 10 including a cushioning conversion machine 12 that converts sheet stock material 14 payed off from a stock roll 16 into a resilient cushioning product. The cushioning conversion system 10 includes a stock roll transfer assembly 17 that lifts a stock roll 16 at a loading position 18 (the left side of FIG. 1) by means of a pair of roll lifter arms 19 and deposits the stock roll 16 onto laterally spaced apart storage rails 20 at a storage position 24 (the middle region of FIG. 1) of the system 10. The stock roll transfer assembly 17 may be operated as desired to release a stock roll 16 from the storage position 24 to an operating position 30 (the right side of FIG. 1), whereat the stock roll 16 is rotatably supported for supplying stock material 14 to the conversion machine 12. These and other features, as well as the structure of the present invention, will be more fully described below.

The stock roll transfer assembly 17 in the illustrated cushioning conversion system 10 is in part formed by a mount composed of mounting members 34 that are secured to or form a part of a frame 36. The frame 36 includes square-shaped tubular posts or uprights 36u that are laterally spaced apart and extend upwardly from laterally spaced apart frame elements or beams 36b. If desired, the frame 36 may be equipped with casters 40 for rolling of the system 10 from one location to another. The casters 40 (or other wheels) are positioned to provide four-point stable support of the cushioning conversion system 10 on the floor 44. For further details of the frame 36, reference may had to U.S. Pat. No. 5,123,889, which is assigned to the assignee of the present invention, and which is hereby incorporated herein by reference in its entirety.

As will be appreciated by those skilled in the art, the illustrated stock roll transfer assembly 17 facilitates retrofitting existing cushioning conversion systems, such as the type of system disclosed in noted U.S. Pat. No. 5,123,889. However, it should be understood that the elements of the stock roll transfer assembly 17 may be supported in other ways, either as part of the frame 36 or provided as a separate component, such as a cart, positionable adjacent or below the system.

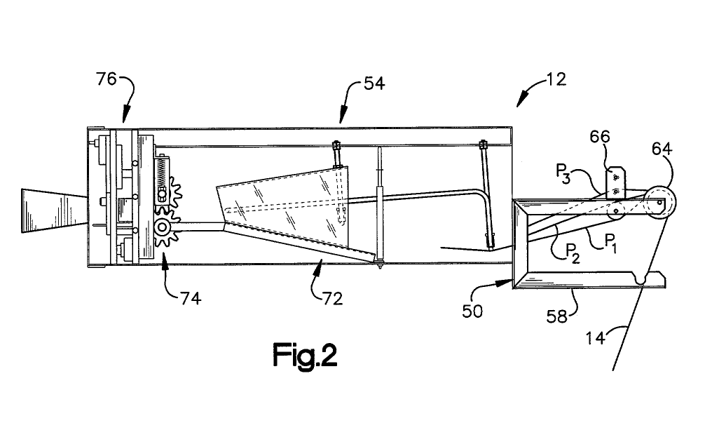

As seen in FIGS. 1 and 2, a pair of laterally spaced apart U-shape brackets 50 are secured to the rear or upstream end of a conversion assembly 54. The upstream projecting legs 58 of brackets 50 have journalled therebetween the ends thereof a constant entry roller 64 that provides a non-varying point of entry for the sheet stock material 14 from the stock roll 16. The legs 58 also support therebetween a separating mechanism 66 which receives the sheet stock material 14 from the constant entry roller 64 and separates multiple plies P₁ through P₃ from one another prior to passage to a forming assembly in the conversion machine 12. For further details concerning the constant entry roller and separating mechanism, reference may be had to U.S. Pat. No. 4,750,896 which is also assigned to the assignee of this invention.

The illustrated cushioning conversion assembly 54 shown in FIG. 2 is part of the illustrated exemplary cushioning conversion machine, although other cushioning conversion machines are contemplated as being useful in practicing the invention. The illustrated cushioning conversion machine 12 includes a forming assembly 72, a feed/connecting assembly 74 and a cutting assembly 76. For a detailed disclosure of the cushioning conversion machine shown in FIG. 2, reference may be had to noted U.S. Pat. No. 5,123,889.

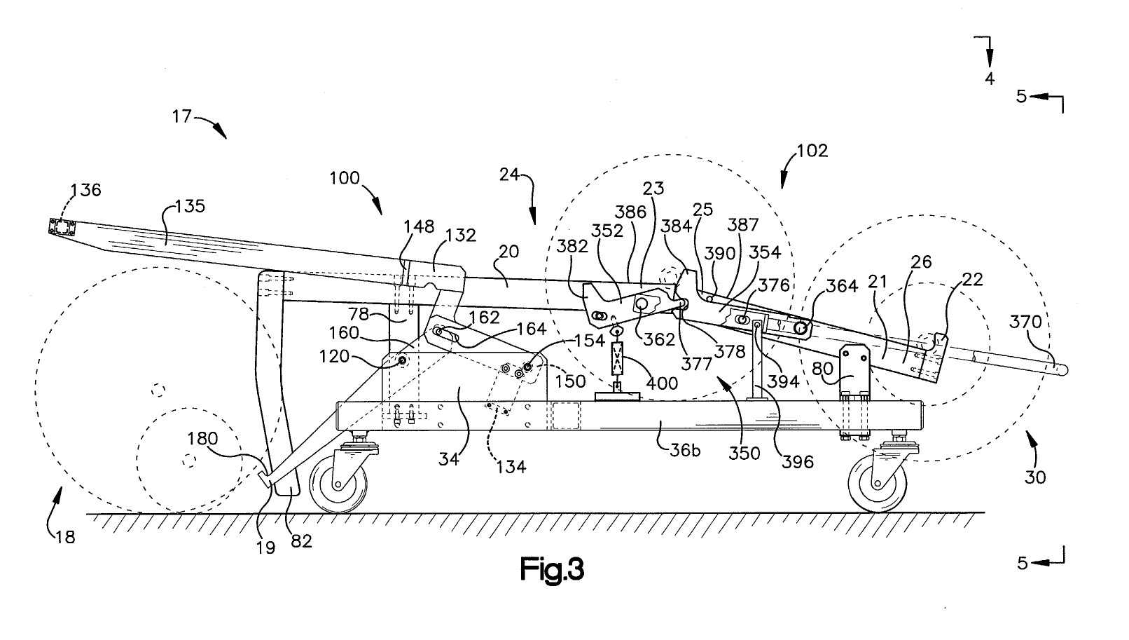

Details of the stock roll transfer assembly 17 will now be described initially with reference to FIGS. 3 through 5. As shown in FIG. 3, the stock roll transfer assembly 17 includes a storage ramp formed by a pair of laterally spaced apart storage rails 20 spaced from and mounted to the base 36b of the frame 36 by a pair of loading end vertical bars 78 at the loading end 18. At the operating end 30, the stock roll transfer assembly 17 includes a transfer guide formed by a pair of laterally spaced apart guide rails 21 spaced from and mounted to the base 36b by a pair of operating end vertical bars 80. The storage rails 20 are sloped at a slight decline and thus cause stock rolls 16 supported thereon to roll by gravity in a direction from the loading position 18 towards the guide rails 21 and operating position 30. The guide rails 21 are sloped at a slightly greater decline and likewise bias the stock rolls 16 to the operating position 30. Ends 23 of the storage rails 20 are connected in abutting relation to ends 25 of the guide rails 21. Ends 26 of the guide rails 21 at the operating position 30 include respective upwardly projecting roll holding tips 22 which hold the stock roll 16 in the operating position 30 for paying off of stock material therefrom by the conversion machine 12 in the manner described above.

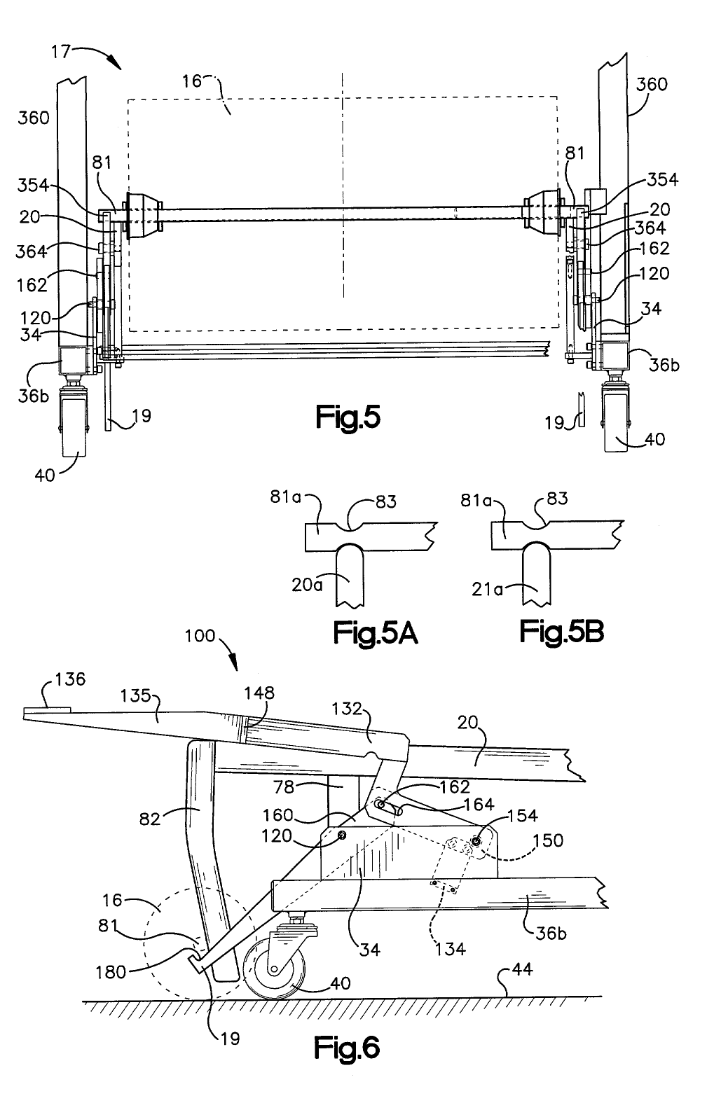

The storage rails 20 are configured to store at least one and generally a plurality of stock rolls 16. Of course, the larger is the diameter of the stock rolls 16, the fewer is the number of stock rolls 16 that may be stored on the storage rails 20. The stock roll 16 is rotatably mounted on a stock roll spindle 81 such as, for example, an axle rod or a holder like that described in U.S. Pat. No. 5,749,539 which is also assigned to the assignee of this invention. As shown in FIG. 5, the distal ends of the spindle 81 rest on or ride along the storage rails 20 with the lower diametric portion of the stock roll 16 extending below the tops of the storage rails 20.

To facilitate guiding the stock roll spindle 81 onto the storage rails 20 and self-aligned movement of the stock roll 16 on the storage rails 20, the ends of the spindle 81 include circumferential grooves 83, as shown for example in the stock roll spindle 81a of FIG. 5a, which correspond in shape with the top portions of storage rails 20a. The grooves 83 enable point contact between the ends of the spindle 81a and the storage rails 20a and limit lateral shifting movement therebetween. As shown in FIG. 5b, the guide rails 21 include similar top portions to facilitate self-aligned movement of the stock rolls thereon. Other means of guiding the spindle 81 onto and/or linearly along the storage rails 20 and/or guide rails 21 are also contemplated; for example, the spindle 81 may be equipped with pulleys mounted at its respective ends which match the cross section of the storage rails 20 and/or guide rails 21.

At the loading end 18 of the cushioning conversion system 10 the storage rails 20 terminate at respective laterally spaced apart and generally parallel guides 82. The lateral guides 82 extend downward from the storage rails 20 to slightly above the floor 44 (FIG. 6), or a distance from the floor 44 less than the radius of the smallest stock roll 16 desired to be loaded and stored on the storage rails 20. As is further described below in reference to FIG. 6, the lateral guides 82 function as locator posts at which a spindle 81 is rolled up against in abutting relation to position the stock roll 16 thereon for lifting by the roll lifter arms 19 to the storage rails 20. The lateral guides 82 also function to limit lateral shifting movement of the stock roll 16 therebetweeen as the stock roll 16 is being raised to the storage rails 20. The lateral guides 82 further function to guide the spindle 81 onto the storage rails 20 when the spindle 81 has been raised to the storage rail level. The radius of curvature of the lateral guides 82 generally corresponds to the arcuate path followed by the distal ends of the roll lifter arms 19 during the raising of a stock roll 16.

The stock roll transfer assembly 17 further includes a stock roll loading assembly 100 and a stock roll storage assembly 102. It will be appreciated that the stock roll loading assembly 100 and the stock roll storage assembly 102 are independent mechanisms forming part of the exemplary cushioning conversion system 10. If desired, either of the stock roll loading assembly 100 and the stock roll storage assembly 102 may be retrofitted into other types of existing cushioning conversion systems.

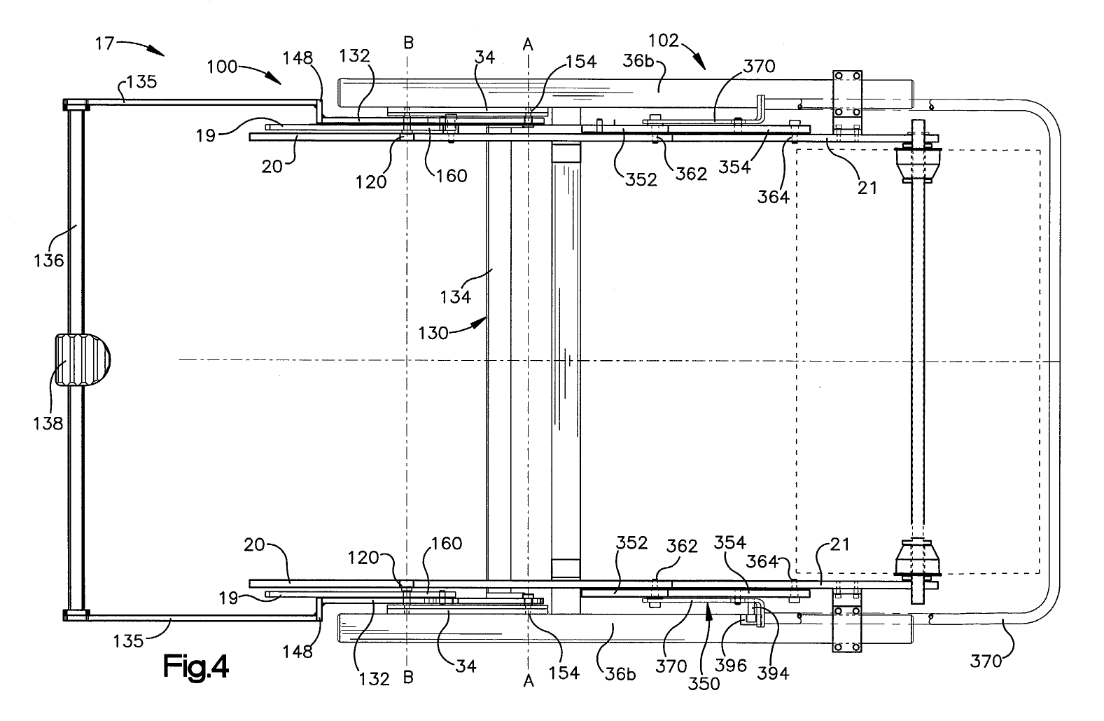

The stock roll loading assembly 100 includes the aforementioned pair of laterally spaced apart roll lifter arms 19. The roll lifter arms 19 are mounted to the brackets 34 by respective shoulder bolts 120 for pivotal movement about a pivot axis B-B (FIG. 4). The stock roll loading assembly 100 also includes a rectangular shape linkage assembly 130 (FIG. 4) which includes side linkage members 132 both fixedly attached to a torsion bar 134 for rotation therewith. The side linkage members 132 have integral lever arm extensions 135 terminating at an accessible pedal 136 disposed at the loading end 18 of the stock roll transfer assembly 17, the pedal 136 being usable via the manual actuation thereof, to affect a loading operation in the below described manner. Generally, the pedal 136 includes a foot pad 138 for indicating the point at which the pedal 136 should be contacted, which is midway between the storage rails 20.

As will be appreciated, the pedal 136 and associated lever arms 135 need not be formed as a single piece with the side linkage members 132. For example, the lever arm extensions 135 may be adapted to be removable, for example at junctures 148, to enable the pedal 136 and lever arm extensions 135 to be moved out of the way from the region below the downstream end of the conversion machine 12. Alternatively, the lever arm extensions 135 and respective side linkage members 132 may be adapted for relative telescoping movement.

The bottom leg portions 150 of the respective side linkage members 132 are mounted to the brackets 34 by respective shoulder bolts 154 for pivotal movement about a pivot axis A-A. As shown in FIG. 4, the torsion bar 134, the side linkage members 132, the lever arm extensions 135 and the pedal 136 form a rectangular shape linkage assembly. The rectangular shape linkage assembly minimizes relative uneven or unbalanced movement in the side linkage members 132 and associated lever arm extensions 135. The pedal 136 is spaced from the torsion bar 134 to accommodate large diameter stock rolls that may be loaded into the cushioning conversion system 10; that is, the swing path of the pedal 136 does not interfere with the stock roll 16. The torsion bar 134 is spaced below the pivot axis A-A (FIG. 4) to provide clearance for the lower diametric portion of a large diameter stock roll 16 extending between the storage rails 20.

The lifter arms 19 have associated therewith respective crank segments 160 which extend radially from the pivot axis B-B of the lifter arms 19 opposite the lifter arms 19. As shown, the lifter arm 19 and crank segment 160 at each side of the stock roll transfer assembly 17 are formed as a single piece. The crank segments 160 are pivotally connected to the respective side linkage members 132 at locations radially spaced from the pivot axes of the side linkage members 132 (axis A-A) and lifter arms 19 (axis B-B). The pivot connection between the crank segments 160 and the side linkage members 132 is a sliding pivot (or cam) connection, such as obtained by the crank segments 160 having pins 162 guided in radially elongated slots 164 in the bottom leg portions 150 of the side linkage members 132.

The roll lifter arms 19 form catches or receiving arms 180 at their respective distal ends for receiving and engaging a stock roll 16 or, more particularly, the ends of a stock roll spindle 81. The catches 180 of the roll lifter arms 19 are adapted to engage the distal ends of the stock roll spindle 81 for lifting the stock roll 16 when the roll lifter arms 19 are moved from their loading position (FIG. 6) to their elevated release position (FIG. 8). In the illustrated embodiment, the roll lifter arms 19 of the stock roll transfer assembly 17 extend substantially radially from and substantially perpendicular to the pivot axis B-B thereof. The roll lifter arms 19 extend sufficiently beyond the lateral guides 82 to enable the roll lifter arms 19, and more particularly the catches 180 thereof, to be positioned beneath the ends of the spindle 81 when the ends of the spindle 81 are in abutting relation with the lateral guides 82 (FIG. 6). The length of the roll lifter arms 19 enables a wide range of stock roll diameters to be accommodated, as can be appreciated in view of FIG. 3.

In operation, the roll lifter arms 19 cooperate to support therebetween the stock roll 16. Each roll lifter arm 19 is supported for pivotal movement, although other arrangements could be employed. The linkage connections between the roll lifter arms 19 and side linkage members 132 permit the roll lifter arms 19 to respond to the action of the pedal 136 such that the roll lifter arms 19 rotate upwardly about the shoulder bolt pivots 120 and thereby raise the stock roll 16 from the loading position (FIG. 6) to the elevated release position (FIG. 8).

It is noted that various means could be employed to raise the roll lifter arms 19 between the loading position (FIG. 6) and the elevated release position (FIG. 8) including, for example, powered means such as an electric motor. The motor may be mounted to the frame 36 and connected to the pedal (lever end) 136 by a suitable drive mechanism such as a rack and pinion. As another example, a hydraulic or pneumatic piston-cylinder assembly may be connected between the pedal 136 and the frame 36 such that extension and retraction of the piston-cylinder assembly raises and lowers the roll lifter arms 19. Manually operated devices such as toggle mechanisms, ratchet and pawl mechanisms, etc. may also be used.

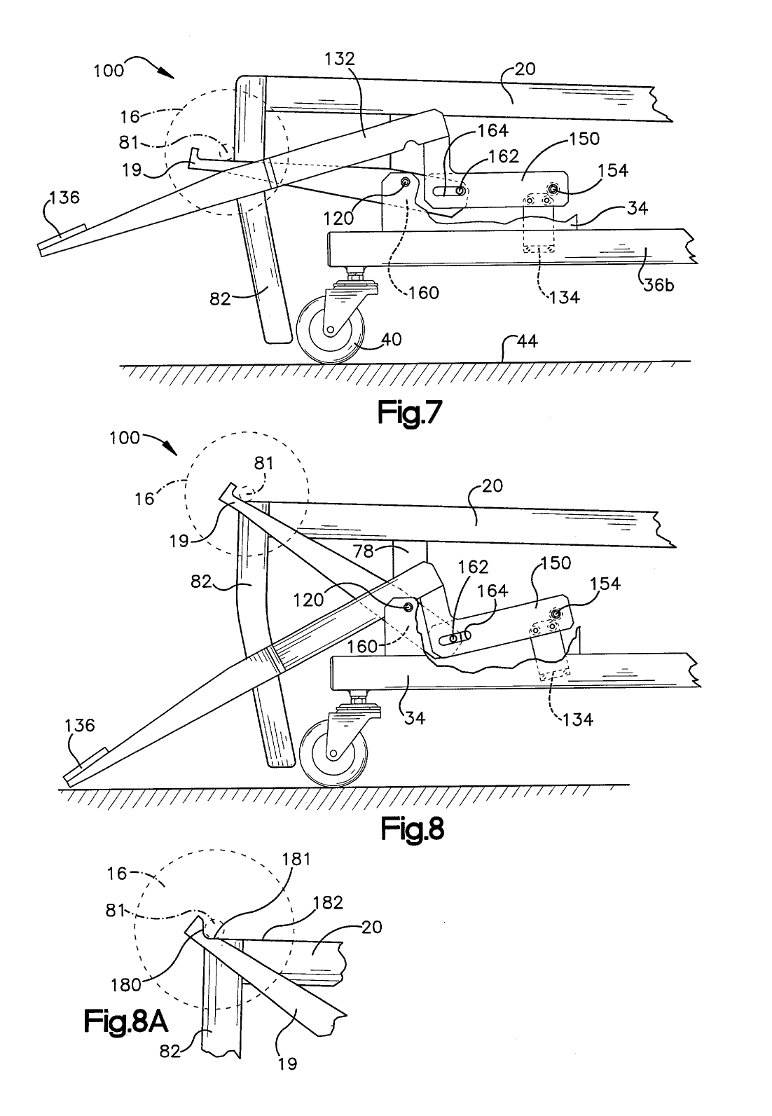

Referring to FIGS. 6 through 8, the manner in which a stock roll 16 is loaded onto the storage rails 20 is sequentially illustrated. In FIG. 6, the roll lifter arms 19 are in a loading position 18 ready to engage and lift a stock roll 16. As the pedal 136 is depressed the catches 180 of the roll lift arms 19 engage the underside of the ends of the spindle 81 and raise the spindle 81 substantially alongside the lateral guides 82 (FIG. 7). When the pedal 136 has been moved to its fully depressed position as shown in FIG. 8, the roll lifter arms 19 have moved to the elevated release position whereat the spindle 81 (and the stock roll 16 supported thereby) is deposited onto the storage rails 20. As shown in FIG. 8a, the catches 180 of the roll lift arms 19 may be sized and shaped so that the spindle 81 is released when a bottom wall 181 of the catches 180 is aligned with the top surface 182 of the storage rails 20. Upon release of the pedal 136, the pedal 136 returns to an upward position and the roll lift arms 19 return to their loading position, as shown in FIG. 6.

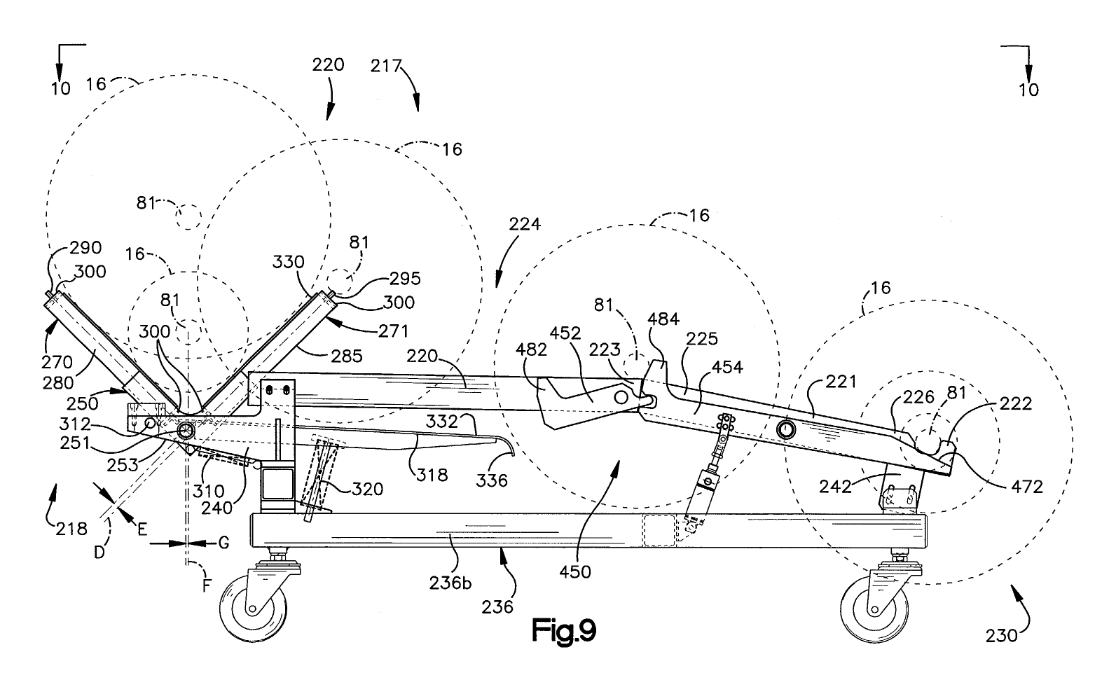

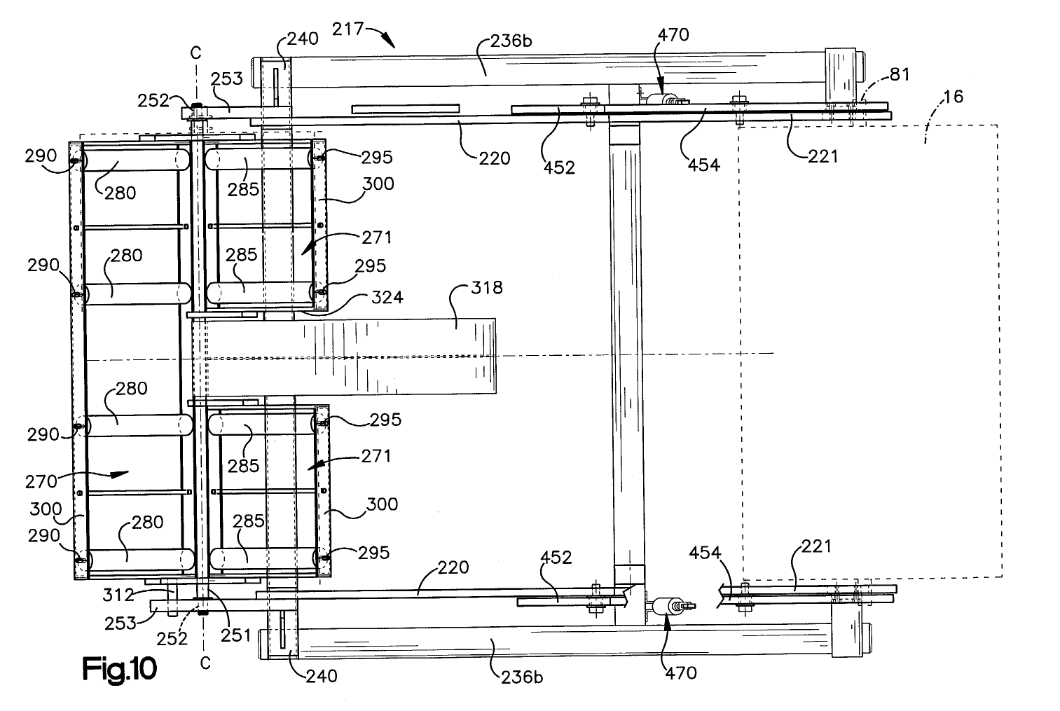

Referring now to FIGS. 9 and 10, there is shown another embodiment of a stock roll transfer assembly 217 in accordance with the present invention embodying an alternative stock roll loading assembly 220. The stock roll loading assembly 220 enables stock rolls 16 to be loaded laterally from the side of the stock roll transfer assembly 217 rather than from the end thereof, as is the case with the above described stock roll loading assembly 100.

Referring to FIG. 9, the stock roll transfer assembly 217 includes a storage ramp formed by a pair of laterally spaced apart storage rails 220 spaced from and mounted to a base 236b of a frame 236 by a pair of vertical bars 240 at the loading end 218. At the operating end 230, the stock roll transfer assembly 217 includes a transfer guide formed by a pair of laterally spaced apart guide rails 221 spaced from and mounted to the base 236b by a pair of vertical bars 242. The storage rails 220 are sloped at a slight decline and thus cause stock rolls 16 supported thereon to roll by gravity in a direction from the loading position 218 towards the guide rails 221 and operating position 230. The guide rails 221 are sloped at a slightly greater decline and likewise bias the stock rolls 16 to the operating position 230. Ends 223 of the storage rails 220 are connected in abutting relation to ends 225 of the guide rails 221. Ends 226 of the guide rails 221 at the operating position 230 include respective upwardly projecting roll holding tips 222 which hold the stock roll 16 in the operating position 230 for paying off of stock material therefrom by the conversion machine 12 in the manner described above.

The stock roll loading assembly 220 includes a V-shaped cradle assembly 250 which has an axle 251 mounted at its ends 252 to respective extension arms 253 of the vertical bars 240 for pivotal movement about a pivot axis C-C (FIG. 10). The legs of the V-shape cradle assembly 250 form walls 270 and 271 of rollers, the wall 270 carrying a plurality of rollers 280 and the wall 271 carrying a plurality of rollers 285. The rollers 280 of wall 270 are parallel to each other, as are the rollers 285 of the wall 271. The rollers 280 and 285 are mounted to respective axles 290 and 295 for rotational movement, the axles 290 and 295 being supported at their ends by walls 300 which form part of the supporting structure of the V-shape cradle assembly 250. The angular spacing between the respective walls of rollers 270 and 271 is about 90 degrees in the illustrated embodiment, although other angles could be employed.

In FIG. 9, the stock roll loading assembly 220 is shown in a loading position. In the loading position, one wall of rollers 270 extends angularly upwardly to the left and the other wall of rollers 271 extends angularly upwardly to the right. A stock roll 16 can, for example, be loaded onto the walls of rollers 270 and 271 by a cantilevered arm mechanism (not shown) such as, for instance, a simplified version of the mobile supply cart and horizontal support arm shown and described in U.S. Pat. No. 5,297,919. The cantilevered arm mechanism raises the stock roll 16 and laterally transfers the stock roll 16 onto the rollers 280 and 285, causing the rollers 280 and 285 to rotate about their respective axles 290 and 295 thereby to facilitate easy transition of the stock roll 16 thereon. As is shown in FIG. 9, the length of the rollers 280 and 285 enables a wide range of stock roll diameters to be accommodated.

The rollers 280 of the left wall of rollers 270 extend radially outwardly from the pivot axis C-C (FIG. 10) and the rollers 285 of the right wall of rollers 271 extend in a plane D that is offset from the pivot axis C-C, the offset being indicated by the reference letter E in FIG. 9. As a consequence, the line of force F through the center of gravity (here, the axial center) of the stock roll 16 installed on the stock roll loading assembly 220 is offset (to the right in FIG. 9) from the pivot axis C-C, this offset being indicated by the reference letter G. Accordingly, the weight of the stock roll 16 will exert a clockwise moment force on the V-shape cradle assembly 250 as viewed in FIG. 9. As the V-shape cradle assembly 250 rotates about the axis C-C, the spindle 81 which supports the stock roll 16 is lowered onto the storage rails 220.

To hold the V-shape cradle assembly 250 in the loading position, there is provided an extension spring 310 mounted to the bottom of the V-shape cradle assembly 250 and the base of the vertical bar 240. The extension spring 310 counters the slight imbalance in the weights of the respective walls of rollers 270 and 271 when there is no stock roll 16 thereon, and biases the V-shape cradle assembly 250 against a stop 312. When a stock roll 16 is laterally transferred on the walls of rollers 270 and 271 the bias in the extension spring 310 is overcome and the V-shape cradle assembly rotates clockwise in the afore-described manner. After the V-shape cradle assembly 250 releases a stock roll 16 into the storage area 224, the assembly 250 may be rotated counterclockwise against the stop 312 to its loading position (FIG. 9), whereat it will remain until a another stock roll 16 is laterally transferred onto the walls of rollers 270 and 271.

It will be appreciated that the cradle assembly 250 may be other than V-shape to obtain the aforementioned offset which causes the cradle assembly 250 to rotate about the axis C-C and deposit the stock roll 16 onto the storage rails 220. For example, the cradle assembly 250 may be U-shape. Alternatively, the cradle assembly 250 may include a left wall of rollers that remains stationary (for example, the left wall of rollers 270 may be mounted to the extension arms 253 in FIG. 9) and a separate right wall of rollers (for example, the right wall of rollers 271 in FIG. 9) that tilts against the bias of the extension spring 310 to lower the stock roll 16 towards the storage rails 220. Of course, in such instance it may be necessary to modify the relative angle between the left wall of rollers and right wall of rollers (for example, the stationary left wall of rollers may be oriented nearly horizontally and the right wall of rollers may be oriented nearly vertically) to adjust the offset, and/or the spring rate of the extension spring 310 may be modified to counter the imbalance in the weights on opposite sides of the pivot axis C-C.

The stock roll loading assembly 220 includes a damping plate 318 (best seen in FIG. 10) which, with the aid of a compression spring 320, dampens the downward movement of a larger diameter stock roll 16, and consequently the spindle 81 supporting such stock roll 16, as the spindle 81 is lowered to the storage rails 220. This limits vibration loads which may be exerted by larger diameter stock rolls 16 on the storage rails 220. As is shown in FIG. 9, the damping plate 318 is mounted to the axle 251 of the V-shape cradle assembly 250 for pivotal movement about the axis C-C. The spring 320 is disposed underneath the damping plate 318 and is mounted to the base 236b of the frame 236 in the manner illustrated.

As can be seen in FIG. 10, the right wall of rollers 271 includes a rectangular shape opening 324 into and through which the damping plate 318 extends when the stock roll 16 is lowered towards the storage rails 220. With such an arrangement, when the V-shape cradle assembly 250 reaches a position at which the top side 330 of the right wall of rollers 270 is flush with (i.e., in the same plane as) the top side 332 of the damping plate 318, the stock roll 16 contacts and exerts a downward force on the damping plate 318 against the bias force of the spring 320.

It will be recognized that the degree to which the damping plate 318 is depressed (and the associated spring 320 compressed) will depend mainly on the diameter and weight of the stock roll 16. For relatively small diameter stock rolls, the diameter may be such that the stock roll 16 does not contact the damping plate 318 before the spindle 81 supporting such stock roll 16 contacts the storage rails 220, in which case the damper plate 318 remains idle. For relatively large diameter stock rolls, the damping plate 318 remains depressed until the stock roll 16 moves beyond the terminal end of the damping plate 318 (to the right in FIG. 9). As is seen in FIG. 9, the terminal end of the damping plate 318 includes a lip 336 to provide a smooth and gradual release of the stock roll 16 from the damping plate 318.

Referring now to FIGS. 3, 4 and 11 through 14, details of the stock roll storage assembly 102 will now be described. It is first noted, however, that the stock roll storage assembly 102 can be used in connection with either of the above described stock roll loading assemblies 100 and 220. Alternatively, stock rolls 16 may be loaded onto the storage rails 20 by other means, for example, by a loading mechanism which lowers the stock rolls 16 from above the stock roll storage assembly 102.

Turning to FIGS. 3, 4 and 11, the stock roll storage assembly 102 includes the aforementioned pair of laterally spaced apart storage rails 20 and a pair f guide rails. A pair of linkage assemblies 350 mounted to the respective laterally spaced apart storage rails 20 and guide rails 21. Each linkage assembly 350 includes a roll holding dog 352 and a mating roll release dog 354 which cooperate in the below described manner to hold and release a spindle 81 (and accordingly, the stock roll 16 supported thereby) stored on the storage rails 20 in the storage area 24. Each roll holding dog 352 is mounted to a storage rail 20 for pivotal movement by respective shoulder bolts 362, and each roll release dog 354 is mounted for pivotal movement to a guide rail 21 by respective shoulder bolts 364.

A U-shaped roll release lever 370 (only partially shown in FIG. 4) is pivotally connected to the shoulder bolts 362, with the base of the U-shaped roll release lever 370 extending in the front (to the right in FIG. 4) of the stock roll transfer assembly 17. The roll release dogs 354 have pins 376 guided in respective elongated slots 378 (FIG. 11) located in the U-shaped roll release lever 370 to provide a sliding pivot connection between the roll release dogs 354 and roll release lever 370. The pins 376 are located approximately midway between the shoulder bolt 364 and the distal end of the roll release dog 354. With this arrangement, downward movement of the U-shape roll release lever 370 (in FIG. 3) causes the roll release dog 354 to pivot counterclockwise about the shoulder bolt 364 and upward movement of the roll release lever 370 causes the roll release dog 354 to pivot clockwise about the shoulder bolt 364.

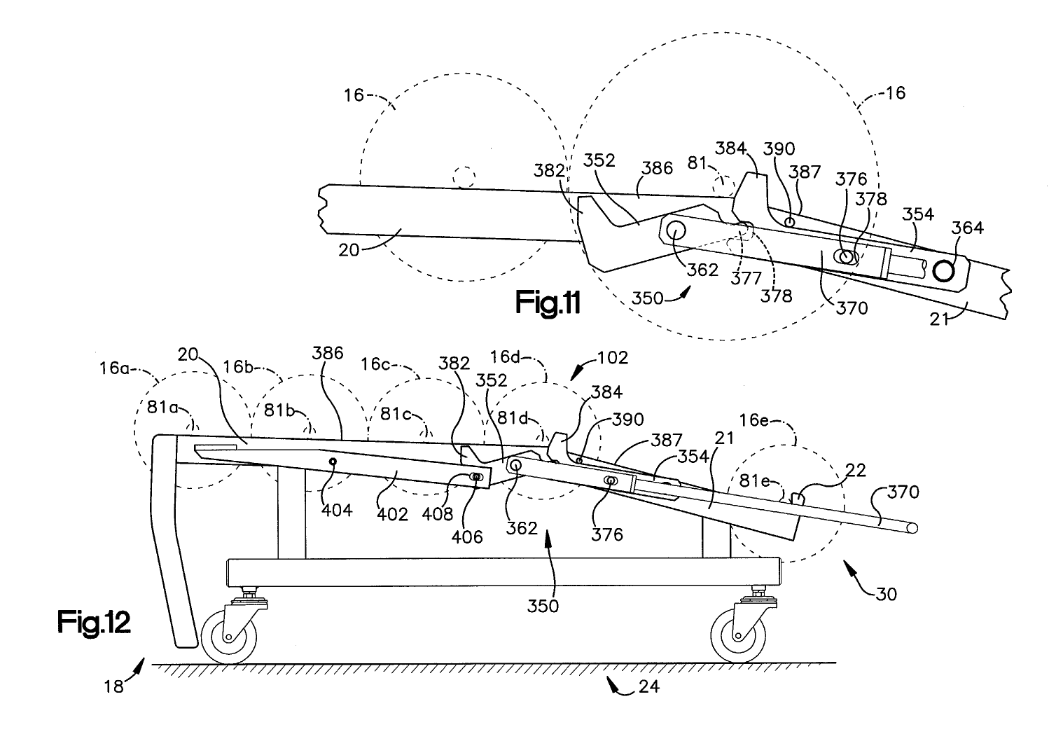

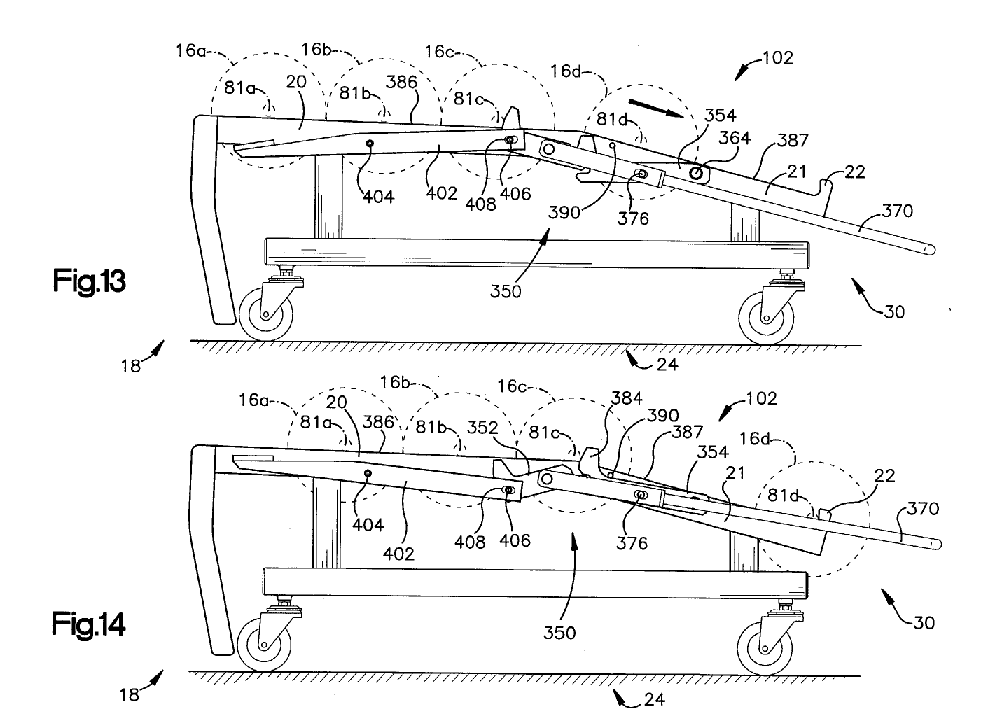

Each roll holding dog 352 further includes a nub 377 (FIGS. 3 and 11) which fits into a slightly larger size recess 378 in the mating roll release dog 354. The coacting relationship between the nub 377 and recess 378 is such that counterclockwise rotation of the roll release dog 354 about the shoulder bolt 364 causes clockwise rotation of the roll holding dog 352 about the shoulder bolt 362, and vice versa. This causes projections 382 and 384 of the respective roll holding dogs 352 and roll release dogs 354 to alternate between rising above and falling below top side surfaces 386 and 387 of the respective laterally spaced apart storage rails 20 and guide rails 21. To this end, it will be recognized that in the illustrated embodiment when the projections 384 of the roll release dogs 354 are fully above the top side 387 of the guide rails 21, the projections 382 of the roll holding dogs 354 are fully below the top side surface 386 of the storage rails 20 (FIGS. 12 and 14), and vice versa (FIG. 13). Stop pins 390 are mounted to the respective spaced apart guide rails 21 to limit the pivotal movement of the roll release dog 354 and thus the linkage assembly 350.

Referring now to FIGS. 12 through 14, the manner in which a stock roll 16 is released from the storage, or ready-to-release position 24, to the roll holding tips 22 at the operating position 30 is sequentially illustrated. In FIG. 12, four abutting stock rolls 16a-16d are shown loaded in the storage position 24 and one stock roll 16e is shown in the operating position 30 of the stock roll storage assembly 102. It is noted that, because of the decline, or slope, provided in the storage rails 20, the four stored stock rolls 16a-16d are gravitationally biased towards the operating position 30. The projections 384 of the roll holding dogs 354, however, hold the four abutting stock rolls 16a-16d in the storage area 24 by preventing spindle 81d, which abuts projection 384, from rotating and moving down (to the right in FIG. 12) the sloped storage rails 20 and guide rails 21.

Once the spindle 81c of the stock roll 16e in the operating position 30 has been removed from the roll holding tips 22, for example because stock roll 16e has been expended or spent by a conversion process, the succeeding or ready-to-release stock roll 16d may be released to the operating position 30. Referring to FIG. 13, this is accomplished by exerting a downward force on the U-shaped roll release lever 370 which, in turn, simultaneously causes the lowering of the projections 384 of the roll release dogs 354 and the raising of the projections 382 of the roll holding dogs 352. The spindle 81d supporting the stock roll 16d is then urged by gravity down storage rails 20 and the guide rails 21 towards the roll holding tips 22, at the operating position 30, to replace the spent stock roll 16e with the succeeding stock roll 16d. The spindles 81a-81c supporting the stock rolls 16a-16c, meanwhile, are urged by gravity down the storage rails 20 until the spindle 81c contacts and is held by the projections 382 of the roll holding dogs 352.

In FIG. 14, the stock roll 16d is shown in the operating position 30 held by the roll holding tips 22 whereat sheet stock material 14 may be payed off the stock roll 16d by the cushioning conversion machine 12 in the manner described above. Also in FIG. 14, the U-shaped release lever 370 has been moved upward, simultaneously raising the projections 384 of the roll release dogs 354 and lowering the projections 382 of the roll holding dogs 352. This permits the spindle 81c supporting the stock roll 16c to urge by gravity further down the storage rails 20 to the ready-to-release position, with the other stock rolls 16a and 16b trailing therebehind and being held in the storage position 24 by the stock roll 16c.

It is noted that, although not shown, the roll holding tips 22 may be equipped with compression springs to enable the roll holding tips 22 to absorb shock or vibration due to the impact the spindle 81 makes when it contacts the roll holding tips 22. With such an arrangement, when a spindle 81 moves along the guide rails 21 and then contacts the roll holding tips 22 the compression springs in each roll holding tip 22 momentarily compress. The flex in the compression springs substantially absorbs the impact to prevent shock in the stock roll storage assembly 102.

Referring to FIG. 3, a pair of spring members 400 are mounted between the respective roll holding dogs 352 and the base members 36b of the frame 36 to downwardly bias the roll holding dogs 352 and, consequently, bias the roll release lever 370 to the upward position (shown in FIG. 3). Also, in order to maintain the roll release lever 370 in an upward position, a spring loaded latch pin 394, or other releasable latching device, is mounted to one of the base members 36b of the frame 36 via vertical standoff member 396. A side wall of the roll release lever 370 has an aperture for receiving the latch pin. To release the roll release lever 370, the pin 394 may be pulled out against the spring biasing force (towards the bottom of the page in FIG. 4).

An alternate roll release lever 402 is shown in FIGS. 12 through 14. The alternate roll release lever 402 performs the same functions as the U-shaped roll release lever 370 except that it is disposed on a side of the stock roll storage assembly 102. More specifically, the alternate roll release lever 402 is mounted for pivotal movement to a storage rail 20 by a shoulder bolt 404. The roll holding dog 352 has a pin 406 guided in an elongated slot 408 in the alternate roll release lever 402 to provide a sliding pivot connection between the roll holding dog 352 and the alternate roll release lever 402.

Referring again to FIGS. 9 and 10, there is shown an alternative embodiment of a stock roll storage assembly 440 embodied in the stock roll transfer assembly 217. Here, the linkage assembly 450, and more particularly the roll holding dog 452 and roll release dog 454, operate in substantially the same manner as the linkage assembly 350, except that the roll release lever 370 has been replaced by powered means such as hydraulic or pneumatic piston-cylinder assemblies 470 connected between the respective roll release dogs 454 and the frame 236 such that extension and retraction of the piston-cylinder assemblies 470 raises and lowers the projections 484 of the roll release dogs 454 (and, accordingly lowers and raises the projections 482 of the roll holding dogs 452).

Also in reference to the stock roll transfer assembly 217 shown in FIGS. 9 and 10, the stock roll storage assembly 440 includes an ejection mechanism wherein the lengths of the roll release dogs 454 are increased so as to extend further towards the operating position 230 and are facilitated with appropriate ramp portions 472. When the roll release dogs 454 are rotated counterclockwise (in FIG. 9) to release a succeeding stock roll from the storage position 224, the ramp portions 472 eject the spent roll axle 81 presently in the operating position 230. Alternative means of ejecting the spent roll axle are also contemplated by the present invention, for example, solenoid actuators may be used to eject the spent roll axle upon actuation of the piston-cylinder assemblies 470.

It is also noted that the roll holding dogs 352 and 452 of the respective stock roll storage and release assemblies 102 and 440 may be omitted, if desired. The storage rails 20 and 220 and guide rails 21 and 221 of the respective stock roll storage assemblies 102 and 440 are inclined downwardly towards the operating position. In the illustrated embodiment, the guide rails 21 and 221 have a greater slope than the storage rails 20 and 220 and the guide rails 21 and 221 are generally located downstream of the roll holding dog projections 384 and 484, with the storage rails 20 and 220 being generally located upstream thereof. Accordingly, when a stock roll 16 is released from the storage position 24 (or 224) the released stock roll 16 travels on the guide rails 21 (or 221) at a faster rate downwardly towards the operating position 30 (or 230) than does the next succeeding stock roll 16 on the storage rails 20 (or 220) and still in the storage position 24 (or 224). This ensures that the roll release dog projections 384 (or 484) snap back to their original or spring biased position to prevent the succeeding roll from moving down the storage rails 20 (or 220) and along the guide rails 21 (or 221). Of course, this also enables sufficient time for the succeeding roll to move beyond the roll release dog projections 384 (or 484).

It will be appreciated that the guide rails 21 and 221 may be sloped at a smaller angle relative to the horizontal than the storage rails 20 and 220, or at the same angle relative to the horizontal as the storage rails 20 and 220, or even parallel to the horizontal. The selection of the angles relative to horizontal for the storage rails 20 and 220 and the guide rails 21 and 221 may be based on, for example, the amount of momentum necessary for the stock roll to travel to the operating position 30 and 230, the friction in the storage rails 20 and 220 and the guide rails 21 and 221, or the desired rate of travel of the stock roll on the storage rails 20 and 220 and guide rails 21 and 221.

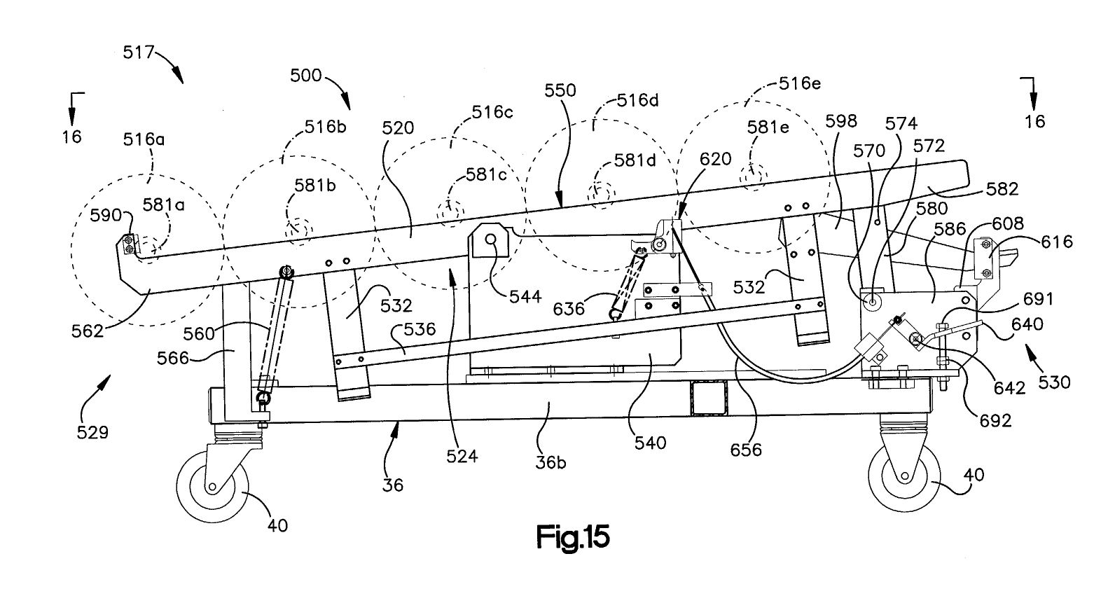

Referring now to FIGS. 15 through 23, there is shown another embodiment of a stock roll transfer assembly 517 in accordance with the present invention embodying a stock roll storage assembly 500. In the several Figures, like reference numerals represent like components. Unlike the stock roll transfer assemblies 17 and 217, the depositing of stock rolls onto the stock roll transfer assembly 517 is at the same end as that at which a stock roll is unwound for loading into the cushioning conversion machine 12; that is, the operating end and loading end of the stock roll transfer assembly 517 are at the same end. By way of comparison, the depositing of stock rolls onto the stock roll transfer assemblies 17 and 217 is at the opposite end as that at which a stock roll is unwound for loading into the conversion machine 12; that is, the operating and loading ends of the stock roll transfer assemblies 17 and 217 are at opposite ends.

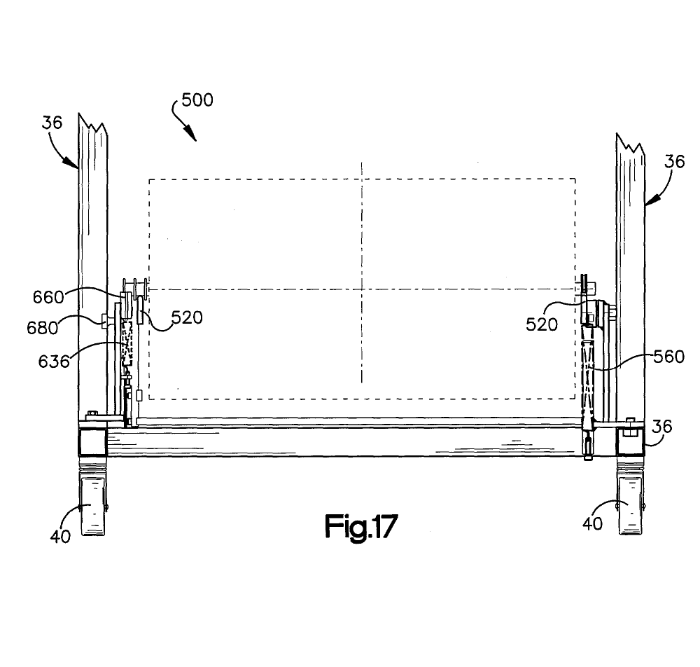

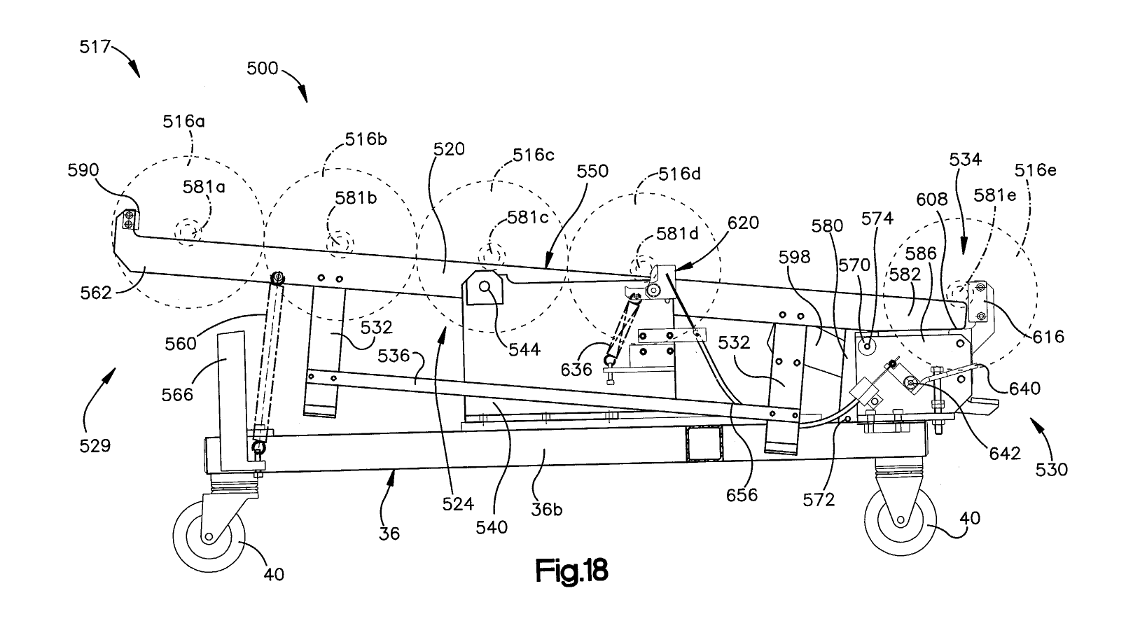

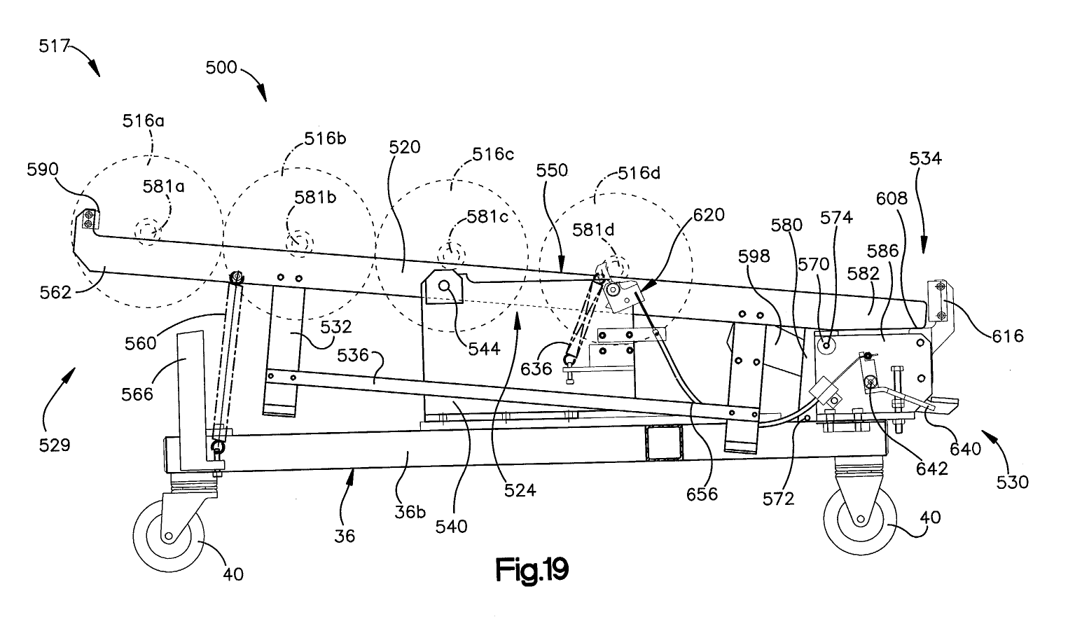

The stock roll storage assembly 500 functions to store and release stock rolls 516a-516e, and to support same for paying off of stock material therefrom by the conversion machine 12 in the manner described above. To facilitate the description herein, the left portion of the stock roll storage assembly 500 shown in FIGS. 15, 18 and 19 is referred to herein as the storage end 529 of the stock roll storage assembly 500, and the right portion of the stock roll storage assembly 500 shown in FIGS. 15, 18 and 19 is referred to as the loading/operating end 530 of the stock roll storage assembly 500. In FIG. 15, five abutting stock rolls 516a-516e are shown loaded in a storage area 524, the stock rolls 516a-516e being gravitationally biased towards the storage end 529 of the stock roll storage assembly 500. In FIG. 18, four abutting stock rolls 516a-516d are shown in the storage area 524, and one stock roll 516e is shown in an operating position 534, the stock roll 516e being gravitationally biased towards the loading/operating end 530 of the stock roll storage assembly 500. In FIG. 19, the stock roll 516d is shown being released from the storage area 524 to the operating position 534. In the exemplary embodiment, the upstream end (i.e., the sheet stock material feeding end) of the cushioning conversion machine 12, although not shown in FIGS. 15, 18 and 19, is above the loading/operating end 530, and the downstream end (i.e., the dunnage dispensing end) of the conversion machine 12 is above the storage end 529.

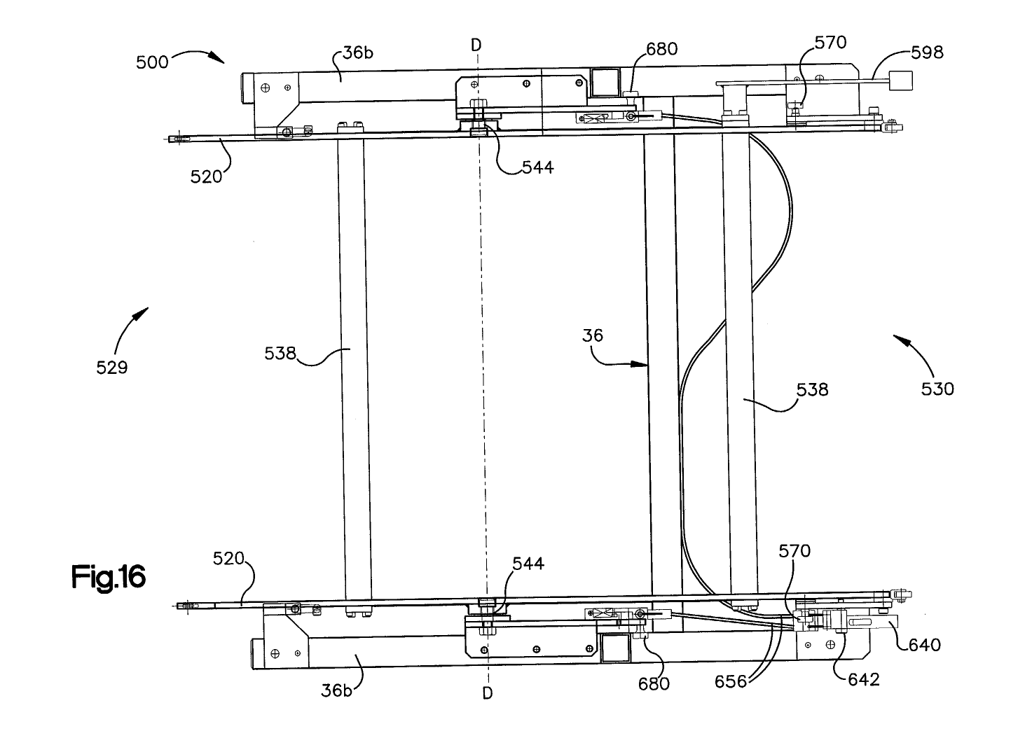

The stock roll storage assembly 500 includes a pair of laterally spaced apart storage rails 520, four vertical linkage members 532, a pair of side linkage members 536, and a pair of cross link members 538 (FIG. 16), which together form a rectangular-box shape cradle assembly 550. The storage rails 520 of the cradle assembly 550 are mounted to mounting brackets 540 by respective shoulder bolts 544 for enabling the cradle assembly 550 to be pivoted about a pivot axis D-D (FIG. 16). The mounting brackets 540, in turn, are mounted to the base 36b of the frame 36 (see FIG. 1). An integral cradle lever arm 598 is integrally connected to the cradle assembly 550 for providing the pivotable movement to same.

The cradle assembly 550 is pivotable between an inclined position, which is shown in FIG. 15, and a reverse inclined position, which is shown in FIGS. 18 and 19. In the inclined position, the cradle assembly 550, and more particularly the storage rails 520 thereof, are inclined relative to horizontal from the storage end 529 to the loading/operating end 530 of the stock roll storage assembly 500, and the cradle assembly 550 is ready to receive and store stock rolls deposited thereon. In the reverse inclined position, the cradle assembly 550 is reverse inclined relative to horizontal from the storage end 529 to the loading/operating end 530 of the stock roll storage assembly 500, and may store thereon one or more stock rolls in the storage area 524 and/or may support a stock roll in the operation position 534.

It will be appreciated that the cradle assembly 550, and more particularly the storage rails 520 thereof, when oriented as shown in FIGS. 18 and 19, function as a ramp in a manner similar to that of the ramp formed by the storage rails 20 and 220 of the respective stock roll storage assemblies 102 (FIGS. 3, 4 and 11-14) and 440 (FIGS. 9 and 10). Similarly, the portion of the storage rails 520 downstream of roll holding dogs 620 (described below), when oriented as shown in FIGS. 18 and 19, function as a transfer guide in a manner similar to that of the transfer guide formed by the guide rails 21 and 221 of the respective stock roll storage assemblies 102 and 440. To simplify the description which follows, both the portion upstream of the roll holding dogs 620 as well as the portion downstream of the roll holding dogs 620 will be referred to as the storage rails 520 of the stock roll storage assembly 500. As was previously noted, the guide rails 21 and 221 of the illustrated stock roll storage assemblies 102 and 440 are inclined relative to horizontal at an angle different than that of the respective storage rails 20 and 220. It will be appreciated that the stock roll storage assembly 500 may include guide rails which, when the cradle assembly 550 is oriented in the reverse inclined position shown in FIGS. 18 and 19, are inclined relative to horizontal at an angle different than that of the storage rails 520.

A pair of extension springs 560 are mounted between the respective storage rails 520 and the base members 36b of the frame 36 to downwardly bias respective ends 562 (left side of FIGS. 15, 18 and 19) of the storage rails 520 into contact with respective upright stop members 566 mounted to the frame 36 at the storage end 529 of the stock roll storage assembly 500. The extension springs 560 thus bias the cradle assembly 550 to the inclined position shown in FIG. 15.

A pair of spring loaded latch pins 570, or other releasable latching devices, maintain the cradle assembly 550 in the inclined position or, as is further described below, in the reverse inclined position. The cradle assembly 550 includes a pair of position locking arms 580 which project downwardly from ends 582 (right side of FIGS. 15, 18 and 19) of the respective storage rails 520. The position locking arms 580 have respective lower apertures 572 and upper apertures 574. The latch pins 570 are mounted to respective mounting brackets 586 at the loading/operating end 530 of the stock roll storage assembly 500 which, in turn, are mounted to the frame 36.

In the inclined position, the latch pins 570 are spring biased for automatic insertion into the respective lower apertures 572 of the position locking arms 580. As is further described below, to enable rotation of the cradle assembly 550 from the inclined position to the reverse inclined position, the latch pins 570 are pulled out from the lower apertures 572 against the spring biasing force; that is, towards the respective top and bottom of the page in FIG. 16.

FIG. 15 shows the manner by which the stock rolls 516a-516e may be loaded onto the stock roll transfer assembly 517. The cradle assembly 550 is pivotably biased (counterclockwise in FIG. 15) about the pivot axis D-D (FIG. 16) into the inclined position; that is, such that the ends 562 of the storage rails 520 abut the upright stop members 566. In the inclined position, the lower apertures 572 in the position locking arms 580 align with the respective spring loaded latch pins 570, the latch pins 570 thus automatically inserting into same to prevent the cradle assembly 550 from pivoting to the reverse inclined position when the stock rolls 516a-516e are deposited thereon. Stock rolls 516a-516e may then be deposited onto the storage rails 520 of the cradle assembly 550 from the loading/operating end 530 of the stock roll storage assembly 500. Because the storage rails 520 are inclined, or sloped, stock rolls 516a-516e deposited thereon are gravitationally biased towards the storage end 529 (i.e., to the left in FIG. 15) and the storage area 524. The storage rails 520 include respective upwardly projecting catches or receiving arms 590 which stop movement (leftwardly in FIG. 15) of the leftmost spindle 581a and, consequently, the stock roll 516a and the abutting stock rolls 516b-516e.

To move the stock roll 516e from the storage area 524 and into the operating position 534, the cradle assembly 550 is tilted from the inclined position shown in FIG. 15 to the reverse inclined position shown in FIGS. 18 and 19. To accomplish this, the latch pins 570 are first pulled out from the lower apertures 572 in the position locking arms 580 to free the cradle assembly 550 for pivotable movement from the inclined position. The integral cradle lever arm 598, which is connected to the vertical linkage member 532 at one side (the top of FIG. 16) of the cradle assembly 550, is then pushed down until the ends 582 of the storage rails 520 abut a pair of stop members 608 at the loading/operating end 530 of the stock roll storage assembly 500. This causes the cradle assembly 550 to pivot (clockwise in FIGS. 15, 18 and 19) about the pivot axis D-D (FIG. 16) from the inclined position to the reverse inclined position. In the reverse inclined position, the respective upper apertures 574 in the position locking arms 580 align with the respective spring loaded latch pins 570, the latch pins 570 thus automatically inserting into same to maintain the cradle assembly 550 in the reverse inclined position, and thus prevent the cradle assembly 550 from pivoting to the inclined position.

Referring to FIG. 18, in the reverse inclined position the spindle 581e supporting the stock roll 516e is urged by means of gravity toward the loading/operating end 530 and into the operating position 534 of the stock roll storage assembly 500. A pair of upwardly projecting spindle stops 616 are disposed at opposite sides of the stock roll storage assembly 500 and are connected to the respective mounting brackets 586. The spindle stops 616 stop the spindle 581e from further movement beyond the operating position 534 and hold the stock roll 516e at the loading/operating end 530 for paying off of stock material therefrom by the conversion machine 12 in the manner described above.

As the spindle 581e travels down the storage rails 520, the spindle 581d of the next in sequence stock roll 516d, as well as the other succeeding stock rolls 516a-516c in the storage are 524, are urged by gravity down the storage rails 520. A pair of L-shaped roll release dogs 620 are disposed at opposite sides of the stock roll storage assembly 500 and prevent further movement of the spindle 581d, and thus hold the succeeding stock rolls 516a-516d in the storage area 524 and, more particularly, in FIG. 18 to the left of the roll release dogs 620.

Details of the roll release dogs 620 are shown in FIGS. 20 and 21. The roll release dogs 620 are mounted to the respective mounting brackets 540 for pivotal movement via respective shoulder bolts 624. Each roll release dog 620 includes a roll holding projection 630 and a roll pusher projection 632.

Extension springs 636 are mounted between the respective roll pusher projections 632 of the roll release dogs 620, and respective anchoring brackets 640 as shown to pivotably bias (counterclockwise in FIGS. 15, 18, 19 and 21) the roll release dogs 620 to a roll holding position (FIGS. 15, 18 and 21). Further counterclockwise pivoting movement beyond that shown in FIGS. 15 and 18 is prevented by respective control cables, which are described in greater detail below.

Referring now to FIG. 19, once the spindle 581e of the stock roll 516e in the loading/operating position 530 has been removed from the operating position 534, for example because stock roll 516e has been expended or spent by a conversion process, the succeeding or ready-to-release stock roll 516d may be released toward the loading/operating end 530 and into the operating position 534.

A spring biased roll release lever 640 is operative, when pressed downward by an operator, to release a stock roll from the storage area 524. The roll release lever 640 is located at the loading/operating end 530 of the stock roll storage assembly 500 and is mounted for pivotal movement to the mounting bracket 586 (in the illustrated embodiment, the side opposite that at which the integral cradle lever arm 598 is mounted) by a shoulder bolt 642. The roll release lever 640 is biased against being pushed downward (counterclockwise in FIGS. 15, 18 and 19) by the extension springs 636 connected to the roll release dogs 620.

As above noted, the roll release lever 640 is connected to a pair of control cables 656 (FIG. 16). The control cables 656 are connected to respective spring biased plungers 660 (FIG. 21) slidably received in openings of the respective roll holding projections 630 of the roll release dogs 620. As is shown in FIGS. 20 and 21, the plungers 660 include tapered ends 662 which coact with tapered ends 674 of respective spring loaded latch pins 680 (not shown in FIG. 21). The latch pins 680 are biased into respective apertures 690 in the mounting brackets 540, at which condition the latch pins 680 prevent the roll release dogs 620 from being pivoted from the roll holding position.

Referring again to FIG. 19, the roll release lever 640, when pushed downward, pulls the control cables 656 which, in turn, depress the respective spring biased plungers 660, causing the tapered ends 662 of the plungers 660 to contact the tapered ends 674 of the latch pins 680 and urge same out of their respective apertures 690. This clears the pivot path of the roll release dogs 620.

When pushed further down, the roll release lever 640 pivots the roll release dogs 620 (clockwise in FIGS. 15, 18, 19 and 21) against the bias force of the respective extension springs 636 from the roll holding position (FIGS. 18 and 21) to a roll release position (FIG. 19). In so doing, the roll holding projections 630 of the respective roll release dogs 620 pivot “out of the way” of the spindle 581d of the stock roll 516d and, simultaneously, the roll pusher projections 632 of the roll release dogs 620 push or nudge the spindle 581d down the storage rails 520 (FIG. 19). The stock roll 516d is then urged by gravity down the storage rails 520 toward the loading/operating end 530 and into the operating position 534 to replace the spent stock roll 516e.

The spindles 581a-581c supporting the respective next succeeding stock rolls 516a-516c, meanwhile, are urged by gravity down the storage rails 520. However, upon release of the roll release lever 640, the roll release lever 640 automatically returns via the bias force of the extension spring 636 to its upward position (FIGS. 15 and 18), and the roll release dogs 620 automatically return likewise via the force of the respective extension springs 636 to their roll holding positions (FIG. 18) to prevent the next succeeding stock roll 516c, and the stock rolls 516a-516b abutting the next succeeding stock roll 516c, from traversing down the storage rails 520. As is shown in FIGS. 15, 18 and 19, the movement of the roll release lever 640 and, consequently, the control cables 656, is limited by upper and lower stops 691 and 692. As the control cables 656 are connected to the roll release dogs 620, the upper stop 691 limits the return pivotable movement, due to the bias force of the respective extension springs 636, in the roll release dogs 620 (counterclockwise in FIGS. 15, 18, 19 and 21).

It will be appreciated, then, that the pushing of the stock roll 516d from the storage area 524 down the storage rails 520 causes the stock roll 516d to travel down the storage rails 520 at a faster rate towards the loading/operating end 530 than does the next succeeding stock roll 516c urged by gravity down the storage rails 520 to replace the released stock roll 516d in the storage area 524. This ensures that the roll holding projections 630 snap back to their original or spring biased positions to prevent the succeeding roll 516c from traveling down the storage rails 520 beyond the storage area 524.

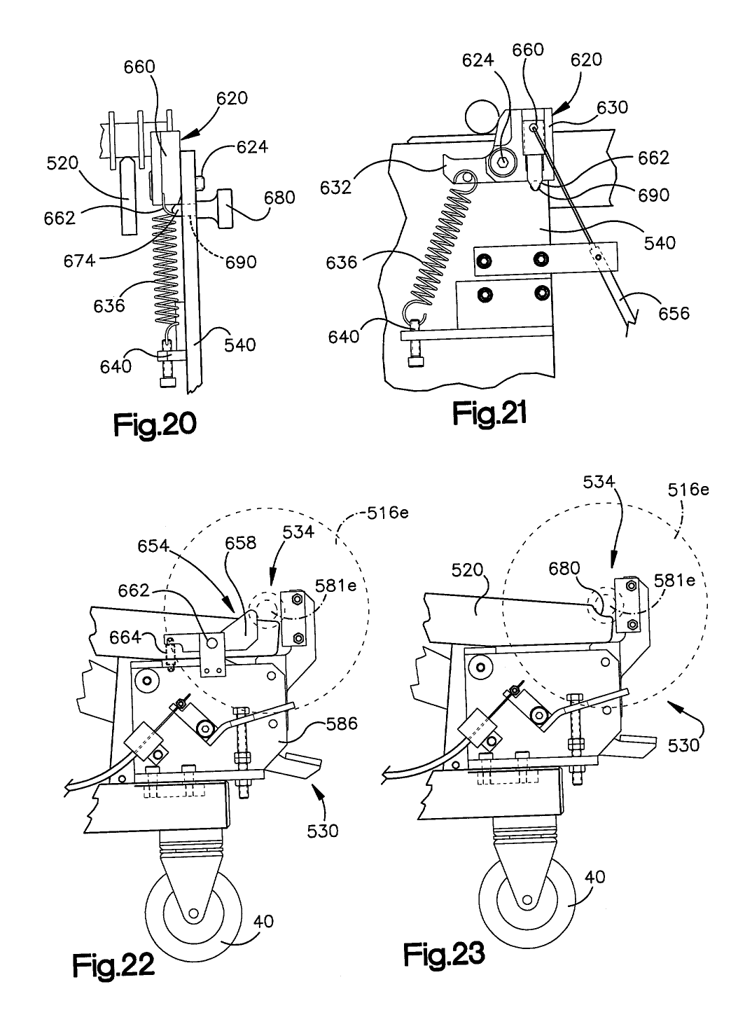

Referring again to FIG. 18, in which there is shown the stock roll 516e in the operating position 534, as sheet stock material is unwound from the stock roll 516e, the stock roll 516e may have a tendency to climb back up the storage rails 520 of the cradle assembly 550. A pair of spring biased roll stops 654 (one shown in FIG. 22) may be used to prevent or at least minimize the likelihood of this occurring. Each spring biased roll stop 654 includes a cam 658 pivotably mounted via a shoulder bolt 662 to the mounting bracket 586, and an extension spring 664 which biases the cam 658 upwardly (counterclockwise in FIG. 22) into a spindle trapping position.

In operation, when a stock roll 516e is traveling down the storage rails 520, the cam 658 is depressed by the spindle 581e of the stock roll 516e against the bias force of the spring 664 and, once the spindle 581e passes the cam 658, the cam 658 automatically returns to the spindle trapping position. In the spindle trapping position, the cam 658 prevents the spindle 581e of the stock roll 516e, when sheet stock material is drawn from the stock roll 516e, from climbing back up the storage rails 520 of the cradle assembly 550.

In an alternative embodiment, as shown in FIG. 23, the storage rails 520 may include recessed portions 680 in which the respective ends of the spindle 581e reside when in the operating position 534. This also has been found to prevent or at least reduce the likelihood of the stock roll 516e from climbing back up the storage rails 520 during a conversion process.

It is noted that the above-described exemplary stock roll transfer assembly 517 is mounted relative to the conversion machine 12 so that its loading/operating end 530 is below the upstream end (i.e., the sheet stock material feeding end) of the cushioning conversion machine 12, and its storage end 529 below the downstream end (i.e., the dunnage dispensing end) of the conversion machine 12. The stock roll transfer assembly 517 may alternatively be mounted relative to the conversion machine 12 so that its loading/operating end 530 is below the downstream end of the cushioning conversion machine 12, and its storage end 529 below the upstream end of the conversion machine 12 (i.e., in a 180 degree fashion relative to that of the above-described stock roll transfer assembly), as by rotating the brackets 566, 540 and 586, cradle assembly 550, and components attached thereto, 180 degrees relative to the stand 36. This enables loading of the stock rolls from the downstream end of the conversion machine 12 rather than the upstream end of the conversion machine 12.

It will be appreciated that any suitable catch device may be used to achieve the desired hold and release functions of the above described roll holding dogs 352 and 452 and the roll release dogs 354 and 454 of the respective stock roll storage assemblies 102 and 440, and the roll holding dogs 620 of the stock roll storage assembly 500. For example, roll holding pins and/or roll release pins with suitable linkage assemblies may be employed. Moreover, the catch devices may be actuated by actuators rather than by linkage assemblies or cable assemblies. Also, a controller may be employed to control the catch devices, the actuators, the linkage or cable assemblies, and/or the timing of the movements of such components.

It will be appreciated that the above described stock roll loading assemblies 100, 220, and the stock roll storage assemblies 102, 440, 500, may be used with any type of system for producing a dunnage product from a roll of sheet material. The present invention contemplates any type of system embodying one or more of the stock roll loading assemblies 100, 220, and the stock roll storage assemblies 102, 440, 500.

Although the invention has been shown and described with respect to certain illustrated embodiments, equivalent alterations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiment or embodiments of the invention. In addition, while a particular feature of the invention may have been described above with respect to only one of several illustrated embodiments, such feature may be combined with one or more other features of the other embodiments, as may be desired and advantageous for any given or particular application.

What is claimed is:

1. A system for producing a dunnage product from a roll of sheet stock material, comprising:
a dunnage converter that converts the stock material into a dunnage product; and,
a stock roll storage assembly which stores one or more stock rolls in a storage area and is operable selectively to release one of said stock rolls from said storage area to an operating position whereat stock material may be drawn therefrom by the conversion assembly for conversion into the cushioning product.

2. A system as set forth in claim 1, wherein the stock roll storage assembly includes a storage ramp for supporting one or more stock rolls in a queue and a roll release dog at a lower end of the ramp which is selectively operable to release a stock roll from the queue for passage to an operating position.

3. A system as set forth in claim 2, wherein the stock roll storage assembly includes an inclined guide and a stop at an end of the inclined guide, and wherein the roll release dog is configured to move between a roll holding position precluding movement of a stock roll thereby and a roll release position allowing the stock roll to move away from the storage ramp and along the inclined guide to and against the stop at the end of the inclined guide.

4. A system as set forth in claim 2, wherein the stock roll storage assembly includes a roll release lever connected by a linkage assembly to the roll release dog, the lever including a base located forwardly of the operating position of the stock roll.

5. A system as set forth in claim 3, wherein the inclined guide includes a pair of laterally spaced-apart guide rails for supporting the projecting ends of a spindle which in turn supports the stock roll, and wherein the stop at the end of the inclined guide engages the projecting ends of the spindle and holds the stock roll in the operating position from which the stock material can be payed off for passage through the dunnage converter.

6. A system as set forth in claim 1, wherein the stock roll storage assembly includes a storage ramp which includes a pair of inclined storage rails mounted to a frame for supporting the projecting ends of an axle that passes through a core of the stock roll.

7. A system as set forth in claim 6, wherein the stock roll storage assembly is mounted to a frame such that the stock rolls are stored in the storage area at a non-parallel angle relative to the horizontal.

8. A system as set forth in claim 6, wherein the stock roll storage assembly includes a cradle assembly pivotably mounted to the frame for movement between an inclined position relative to the horizontal whereat stock rolls are urged by gravity to the storage area, and a reverse inclined position relative to the horizontal whereat the at least one of said stock rolls in the storage area is urged by gravity to the operating position.

9. A system as set forth in claim 8, wherein the cradle assembly is pivotably biased toward the inclined position.

10. A system as set forth in claim 8, wherein the cradle assembly includes a height adjuster arm having first and second apertures, and the stock roll storage assembly further includes a latch pin insertable into the first aperture to maintain the cradle assembly in the inclined position and insertable into the second aperture to maintain the cradle assembly in the reverse inclined position.

11. A system as set forth in claim 1, wherein the stock roll storage assembly includes a roll release dog disposed between the storage area and the operating position, the roll release dog being selectively moveable between a roll holding position whereat the one or more stock rolls in the storage area are held and a roll release position whereat a stock roll is released and transferred from the storage area to the operating position.

12. A system as set forth in claim 11, wherein the roll release dog is connected to a roll release lever, the roll release dog moving between the roll holding position and the roll release position in response to movement of the roll release lever between respective first and second positions.

13. A system as set forth in claim 11, wherein the roll release lever is connected to the roll release dog via a control cable.

14. A system as set forth in claim 11, wherein the roll release dog is spring biased to the roll holding position so that when the roll release dog is moved to the roll released position, to release a stock roll from the storage area, the roll release dog automatically returns to the roll holding position to block a succeeding stock roll from moving from the storage area.

15. A system as set forth in claim 11, wherein the roll release dog includes a roll pusher projection operative to nudge one of the one or more stock rolls from the storage area to the operating position.

16. A system as set forth in claim 12, wherein stock roll storage assembly includes a latch mechanism for selectively locking the roll release lever in the first position.

17. A system as set forth in claim 11, wherein the stock roll storage assembly includes a power actuator which powers the roll release dog between the roll holding position and the roll release position.

18. A system as set forth in claim 11, wherein the stock roll storage assembly includes a roll holding dog upstream of the roll release dog which coacts with the movement of the roll release dog to temporarily block a succeeding roll in the storage area when the roll release dog releases a stock roll and which acts to release the succeeding stock roll to the roll release dog when the roll release dog is returned to its roll holding position.

19. A system as set forth in claim 1, wherein the stock roll storage assembly includes a mount and a pair of laterally spaced apart storage rails mounted to said mount for supporting ends of spindles supporting the respective one or more stock rolls.

20. A system as set forth in claim 19, wherein the storage rails are disposed at a non-parallel angle relative to the horizontal such that gravity urges one of said stock rolls from the storage area to the operating position.

21. A system as set forth in claim 19, further including a stock roll loading assembly for loading one or more stock rolls onto the storage rails in the storage area.

22. A system as set forth in claim 19, wherein the laterally spaced apart rails include respective stock roll spindle holding tips in the operating position to rotatably support the ends of a spindle supporting a stock roll in the operating position.

23. A system as set forth in claim 22, wherein the stock roll storage assembly includes an ejection mechanism for ejecting a spindle from the stock roll holding tips.

24. A system as set forth in claim 23, wherein the ejection mechanism is formed as part of the roll release dog such that when the roll release dog is moved to a roll release position the ejection mechanism simultaneously ejects a spindle from the stock roll holding tips.

25. A system as set forth in claim 19, wherein the laterally spaced apart storage rails are inclined at a greater slope to the horizontal downstream of the roll release dog than upstream of the roll release dog.

26. A system for producing a dunnage product from a roll of sheet stock material, comprising:
a conversion assembly which converts the stock material into the cushioning product and a stock roll loading assembly, the stock roll loading assembly including:
a frame;
a stock roll transfer member mounted to the frame for movement between a load position whereat a stock roll may be loaded thereon and a release position whereat the stock roll is released from the transfer member; and,
a ramp for receiving the stock roll from the transfer member and conveying the stock roll to a position remote from the release position.

27. A system as set forth in claim 26, wherein the ramp includes a pair of elevated laterally spaced apart storage rails mounted to the frame for storing one or more stock rolls thereon.

28. A system as set forth in claim 26, wherein the stock roll transfer member includes a pair of laterally spaced apart roll lifter arms mounted to the frame for movement between the load position and the release position, and a lever connected to the roll lifter arms by a linkage assembly adapted to raise the roll lifter arms to the release position and lower the roll lifter arms to the load position.

29. A system as set forth in claim 28, wherein the roll lifter arms include respective catches which are configured to engage the projecting ends of a spindle supporting a stock roll when the roll lifter arms are raised to lift a stock roll to the release position for transfer onto the ramp.

30. A system as set forth in claim 26, further including a pair of laterally spaced apart guides which extend downward from the ramp to the loading position of the stock roll transfer member such that when a spindle of a stock roll is butted against the guides the spindle will be located in the loading position and thus positioned for capture by the roll lifter arms when the latter are raised.

31. A system as set forth in claim 28, wherein the lever extends outwardly from the loading position to enable the lever to straddle a stock roll as the lever is depressed.

32. A system as set forth in claim 28, wherein the lever is removable.

33. A system as set forth in claim 28, wherein the lever is telescoping.

34. A system as set forth in claim 26, wherein the stock roll transfer member includes a V-shaped cradle assembly pivotally mounted to the frame about a transverse axis between the loading position and the release position, the V-shaped cradle assembly including first and second angularly spaced apart walls adapted for laterally receiving a stock roll therebetween when the cradle assembly is in the loading position.

35. A system as set forth in claim 34, wherein the V-shaped cradle assembly is biased towards the release position such that when a stock roll is installed on the angularly spaced apart walls the V-shaped cradle assembly pivots about the transverse axis to the release position, whereat the stock roll is deposited onto the ramp.

36. A system as set forth in claim 34, wherein the stock roll loading assembly includes an extension spring for maintaining the V-shaped cradle assembly in the loading position.

37. A system as set forth in claim 34, wherein the V-shaped cradle assembly is biased towards the release position by the weight of the stock roll installed on the angularly spaced apart walls.

38. A system as set forth in claim 34, wherein each wall of the V-shaped cradle assembly includes a plurality of parallel rollers extending perpendicularly from the transverse axis of the V-shaped cradle assembly, the length of the rollers being transverse to the direction of lateral receipt of a stock roll into the V-shaped cradle assembly.

39. A system as set forth in claim 34, wherein the walls are angularly spaced apart by about 90 degrees.

40. A system as set forth in claim 34, wherein the stock roll loading assembly includes a damping plate for damping movement of a stock roll being lowered to the release position.

41. A system for producing a dunnage product from a roll of sheet stock material, comprising:
a stand;
a dunnage converter mounted on the stand; and
a stock roll storage assembly mounted to the stand beneath the dunnage converter, the stock roll storage assembly including a stock roll support for supporting a stock roll from which the stock material can be payed off for passage to and through the dunnage converter, and a storage for storing a plurality of stock rolls for sequential supply to the stock roll support.

42. A system as set forth in claim 41, wherein the stock roll support includes a stock roll spindle support for supporting a spindle of the stock roll.

43. A method for loading stock rolls in relation to a cushioning conversion machine, comprising the steps of:
storing a plurality of stock rolls in a storage area of a stock roll storage assembly; and
releasing one of the stock rolls from the storage area for passage to an operating position from which the stock material can be payed off for passage to and through the cushioning conversion machine.
